(19) United States
(12) Patent Application Publication
(10) Pub. No.: US 2017/0201535 A1
(43) Pub. Date: Jul. 13, 2017

(54) ESTIMATION DEVICE AND ESTIMATION METHOD

(71) Applicant: FUJITSU LIMITED, Kawasaki-shi (JP)

(72) Inventor: Masaru Nishiyama, Hachioji (JP)

(73) Assignee: FUJITSU LIMITED, Kawasaki-shi (JP)

(21) Appl. No.: 15/380,312

(22) Filed: Dec. 15, 2016

(30) Foreign Application Priority Data
Jan. 7, 2016 (JP) 2016-001469

(51) Int. Cl. H04L 29/06; G06F 9/455

(52) U.S. Cl. CPC H04L 63/1416; G06F 9/45558; G06F 2009/45587; G06F 2009/45595; G06F 2009/45562

(57) ABSTRACT

An estimation device includes a processor configured to measure a value of a load on a resource of an information processing system. The processor is configured to identify, when the value reaches a predetermined value, a first event corresponding to a current timing from among registered events. The processor is configured to identify first transition information corresponding to the first event from a transition information pool including pieces of transition information indicating transition of a first value of the load since occurrence of the respective events until the first value reaches the predetermined value. The processor is configured to estimate whether an external attack is present based on a degree of correlation between the first transition information and second transition information indicating transition of a second value of the load since occurrence of the first event until the second value reaches the predetermined value.

### CROSS-REFERENCE TO RELATED APPLICATION

This application is based upon and claims the benefit of priority of the prior Japanese Patent Application No. 2016-001469, filed on Jan. 7, 2016, the entire contents of which are incorporated herein by reference.

### FIELD

The embodiment discussed herein is related to an estimation device and an estimation method.

### BACKGROUND

Recently, with the performance improvement of a physical device (hereinafter also referred to as a physical machine), research on virtualization technology to integrate plural virtual devices (hereinafter also referred to as virtual machines) into a single physical machine has proceeded. In the virtualization technology, for example, virtualization software (hereinafter also referred to as hypervisor) allocates resources of the physical machine to the plural virtual machines, enabling each of the virtual machines to provide a service.

When developing an information processing system consisting of virtual machines such as those described above, a business operator who provide services (hereinafter also referred to simply as a business operator) implements, for example, a function (hereinafter referred to as an auto scale function) to automatically generate a new virtual machine and delete an existing virtual machine. Specifically, the business operator implements a function to automatically generate a new virtual machine and delete an existing virtual machine depending on the processing loads for the virtual machines that constitute the information processing system. This enables the business operator to suppress the load in monitoring the operation status of the information processing system.

Related techniques are disclosed in, for example, Japanese Laid-open Patent Publication No. 2011-118525 and Japanese Laid-open Patent Publication No. 2010-226635.

There is a case in which the above-described information processing system receives an external attack that aims to adversely affect a service provided by a business operator. Specifically, the information processing system may receive a denial of service (DoS) attack or the like in which a malicious attacker transmits a huge number of processing requests to the information processing system in order to put an excessive processing load on the information processing system. For this reason, the business operator, for example, deploys a firewall having a function to detect a DoS attack, between an external network and the information processing system. This enables the business operator to detect a presence of DoS attack against the information processing system before the information processing system is adversely affected.

Recently, however, there are cases in which an information processing system receives an economic denial of service (EDoS) attack that aims to place an economic burden on the business operator by causing the business operator to generate an excessive number of virtual machines. Unlike an attack such as the DoS attack described above, in which a huge number of processing requests are transmitted, the EDoS attack is performed by transmitting, to the information processing system, processing requests slightly more than the processing requests transmitted by a normal user, for example. Accordingly, there is a case in which presence of an EDoS attack is not detected, for example, even when the firewall having the DoS attack detection function is employed.

### SUMMARY

According to an aspect of the present invention, provided is an estimation device including a memory and a processor coupled to the memory. The processor is configured to measure a load value of a load on a resource of an information processing system. The processor is configured to identify, when the measured load value reaches a predetermined value, a first change event corresponding to a current timing from change event information stored in the memory. The change event information includes change events for the information processing system in association with occurrence timings at which the respective change events occur. The processor is configured to identify first transition information corresponding to the first change event from a transition information pool stored in the memory. The transition information pool includes pieces of transition information indicating transition of a first load value of the load since the occurrence timings at which the respective change events occur until the first load value reaches the predetermined value. The processor is configured to estimate whether or not an external attack against the information processing system is present on basis of a degree of correlation between the first transition information and second transition information indicating transition of a second load value of the load since a first timing at which the first change event occurs until the second load value reaches the predetermined value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an information processing system;

FIG. 2 is a diagram illustrating processing executed by a virtual machine;

FIG. 3 is a diagram illustrating the processing executed by the virtual machine;

FIG. 4 is a diagram illustrating the processing executed by the virtual machine;

FIG. 5 is a diagram illustrating a hardware configuration of a physical machine;

FIG. 6 is a diagram illustrating a functional configuration of a virtual machine (ASM);

FIG. 7 is a flowchart illustrating external attack estimation processing according to an embodiment;

FIG. 8 is a diagram illustrating the external attack estimation processing according to the embodiment;

FIG. 9 is a diagram illustrating the external attack estimation processing according to the embodiment;

FIG. 10 is a flowchart illustrating the external attack estimation processing according to the embodiment in detail;

FIG. 11 is a flowchart illustrating the external attack estimation processing according to the embodiment in detail;

FIG. 12 is a diagram illustrating a specific example of load information;

FIG. 13 is a diagram illustrating a specific example of change event information;

FIG. 14 is a diagram illustrating a specific example of transition information;

FIG. 15 is a diagram illustrating a specific example of the transition information;

FIG. 16 is a diagram illustrating a specific example of the transition information;

FIG. 17 is a diagram illustrating a specific example of first transition information;

FIG. 18 is a diagram illustrating a specific example of second transition information; and

FIG. 19 is a diagram illustrating a specific example of the transition information.

### DESCRIPTION OF EMBODIMENT

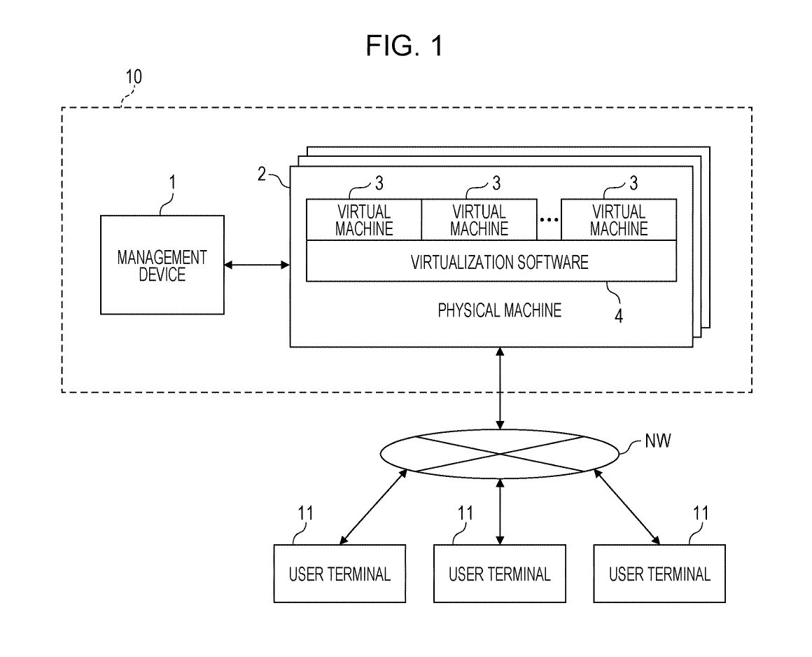

FIG. 1 is a diagram illustrating a configuration of an information processing system 10. For example, the information processing system 10 illustrated in FIG. 1 is provided, in a data center, with a management device 1 as well as physical machines 2 in each of which virtual machines 3 and virtualization software 4 operate. The virtual machines 3 are enabled to be accessed by one or more user terminals 11 through a network NW such as the Internet or an intranet.

In the example of FIG. 1, the information processing system 10 includes plural physical machines 2, and as described later, each of the physical machines includes, for example, a central processing unit (CPU), a random access memory (RAM), and a hard disk drive (HDD). The resources of each physical machine 2 are allocated to plural virtual machines 3.

The management device 1 is able to access the physical machine 2, instructs generation of a virtual machine 3 in the physical machine 2, and manages the generated virtual machine 3.

The virtual machine 3 executes processing for providing service to the user. The detail of the processing executed by the virtual machine 3 is described later.

The virtualization software 4 is infrastructure software to operate the virtual machine 3 by allocating resources of the physical machine 2 to the virtual machine 3, in accordance with an instruction from the management device 1.

The user terminal 11 is a terminal used by the user who receives the service provided by the business operator. Specifically, when a processing request to the virtual machine 3 is input to the user terminal 11 by the user, the user terminal 11 transmits the input processing request to the virtual machine 3. In addition, the user terminal 11 receives an execution result for the processing request transmitted to the virtual machine 3.

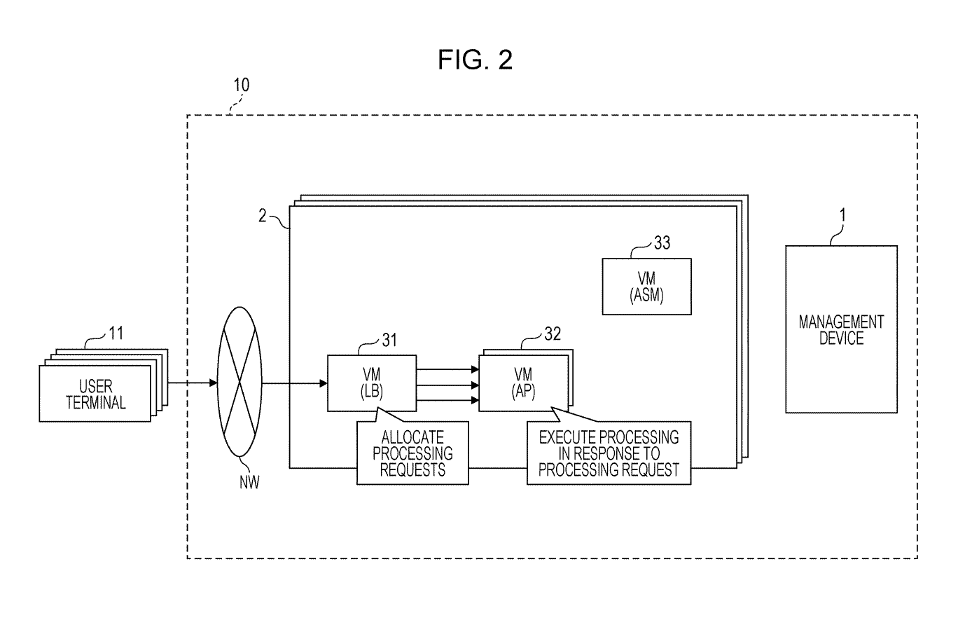

The processing executed by the virtual machine 3 is described below. FIGS. 2 to 4 are diagrams each illustrating the processing executed by the virtual machine 3. Hereinafter, it is assumed that the virtual machines 3 include, for example, a virtual machine 31 (hereinafter also referred to as a VM (LB) 31) that functions as a load balancer which allocates processing requests transmitted from the user terminal 11 to plural virtual machines. It is also assumed that the virtual machines 3 include, for example, a virtual machine 32 (hereinafter also referred to as a VM (AP) 32) in which an application that executes processing in response to the processing request transmitted from the user terminal 11 is operated. It is further assumed that the virtual machines 3 include, for example, a virtual machine 33 (hereinafter also referred to as a VM (ASM) 33) that functions as an auto scale manager to monitor the load in the processing for the VM (AP) 32 and instruct the management device 1 to generate a new VM (AP) 32 and the like on the basis of the load in the processing for the VM (AP) 32. A description follows assuming that plural VMs (AP) 32 are generated in the physical machine 2.

Specifically, when the VM (LB) 31 receives a processing request transmitted from the user terminal 11, the VM (LB) 31 transmits the received processing request to one of the VMs (AP) 32, as illustrated in FIG. 2. The VM (LB) 31 allocates the processing requests to the respective VMs (AP) 32 such that the processing loads for the respective VMs (AP) 32 are equalized, for example.

When the VM (AP) 32 receives the processing request from the VM (LB) 31, the VM (AP) 32 executes processing in response to the received processing request, as illustrated in FIG. 2. The VM (AP) 32 then transmits the execution result of the processing to the user terminal 11 as appropriate.

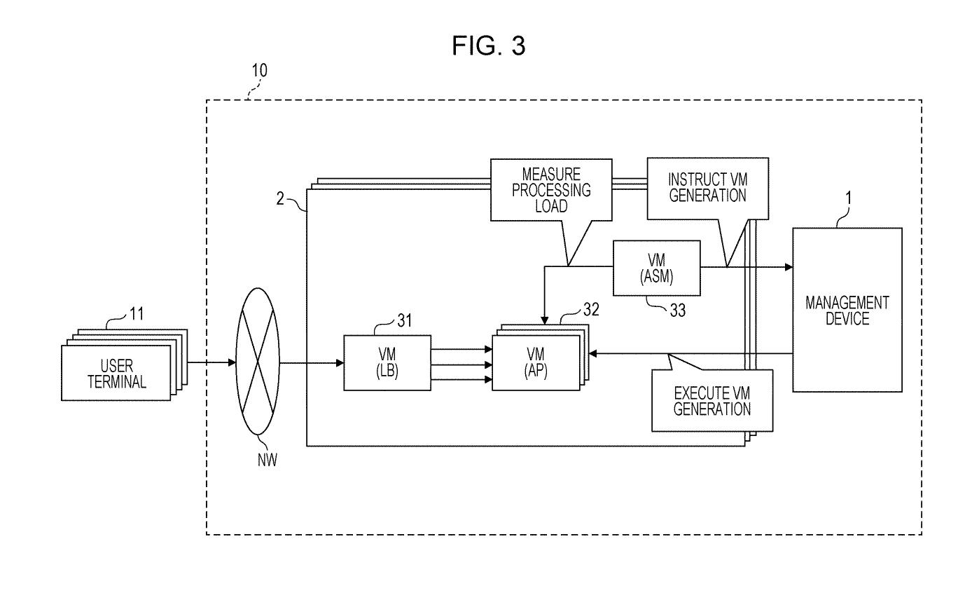

The VM (ASM) 33 obtains the processing load (information indicating the processing load) in the processing for each of the VMs (AP) 32 at each predetermined time, for example, as illustrated in FIG. 3. For example, when a VM (AP) 32 with the obtained processing load equal to or greater than a predetermined value (hereinafter also referred to as first threshold value information) is present, the VM (ASM) 33 instructs the management device 1 to generate a new VM (AP) 32, as illustrated in FIG. 3. As illustrated in FIG. 3, the management device 1 then generates a new VM (AP) 32.

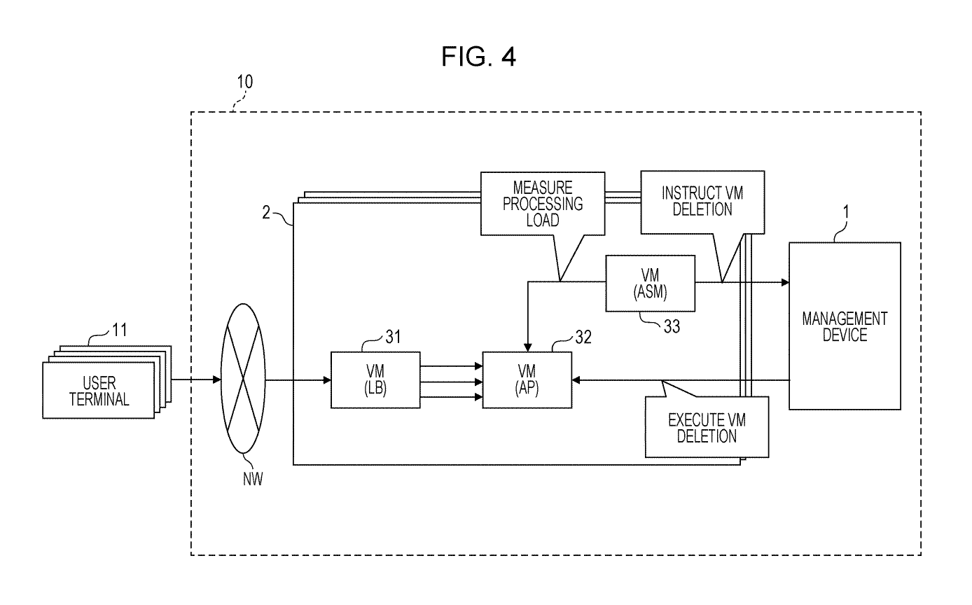

On the other hand, for example, when a VM (AP) 32 with the obtained processing load less than a predetermined value (hereinafter also referred to as second threshold value information) is present, the VM (ASM) 33 instructs, as illustrated in FIG. 4, the management device 1 to delete an existing VM (AP) 32. The management device 1 then deletes an existing VM (AP) 32 as illustrated in FIG. 4.

This enables the business operator to generate or delete a VM (AP) 32 automatically. This thereby enables the work load on the business operator accompanying the monitoring of the information processing system 10 to be reduced.

The VM (ASM) 33 may instruct the management device 1 to generate a new VM (AP) 32 when the load in the processing for all of the VMs (AP) 32 becomes equal to or greater than the first threshold value information. The VM (ASM) 33 may instruct the management device 1 to delete an existing VM (AP) 32 when the load in the processing for all of the VMs (AP) 32 becomes less than the second threshold value information.

The information processing system 10 described with reference to FIG. 2 etc. may receive an external attack that aims to adversely affect the service provided by the business operator. Specifically, such external attack includes a DoS attack in which a malicious attacker transmits a huge number of processing requests in order to impose an excessive processing load on the information processing system 10.

For this reason, the business operator deploys, for example, a firewall having a function to detect a DoS attack between the user terminal 11 and the information processing system 10. This enables the business operator to detect the presence of DoS attack against the information processing system 10 before the information processing system 10 is adversely affected.

However, recently, there are cases in which the information processing system 10 receives an EDoS attack that aims to place an economic burden on the business operator by causing the business operator to generate an excessive number of virtual machines. Unlike an attack such as the DoS attack described above, in which a huge number of processing requests are transmitted, the EDoS attack is performed by transmitting, to the information processing system 10, processing requests slightly more than the processing requests transmitted by a normal user, for example. Accordingly, there is a case in which the presence of an EDoS attack is not detected, for example, even when the firewall having the DoS attack detection function is employed.

The VM (ASM) 33 according to the embodiment hence measures the load on a resource of the information processing system 10 (for example, a resource of the physical machine 2 allocated to the VM (AP) 32). The VM (ASM) 33 then identifies a change event corresponding to the current timing when the measured load on the resource becomes equal to or greater than the first threshold value information, on the basis of change event information in which a change event in the information processing system 10 and the occurrence timing of the change event are associated with each other.

The VM (ASM) 33 then identifies transition information (hereinafter also referred to as first transition information) corresponding to the identified change event, out of a set of transition information that respectively indicates the load transition since the timing in the past, at which a change event occurs, until the load on the resource of the information processing system 10 becomes equal to or greater than the first threshold value information. In addition, the VM (ASM) 33 generates transition information (hereinafter also referred to as second transition information) since the timing, at which the change event corresponding to the current timing occurs, until the load on the resource of the information processing system 10 becomes equal to or greater than the first threshold value information. Then, the VM (ASM) 33 estimates whether or not an external attack against the information processing system 10 is present, on the basis of a degree of correlation between the identified first transition information and the generated second transition information.

Namely, when the load on the information processing system 10 becomes equal to or greater than the first threshold value information, the VM (ASM) 33 determines, before generating a new VM (AP) 32, whether or not the rise in the load on the information processing system 10 to the first threshold value information is caused by an EDoS attack.

Specifically, the VM (ASM) 33 identifies a change event (for example, addition of a new service or the like) that is currently taking place in the information processing system 10. Then, the VM (ASM) 33 identifies the first transition information that indicates the load transition of the information processing system 10 at the time when the change event currently taking place last occurs in the past. In addition, the VM (ASM) 33 compares the second transition information that indicates the current load transition of the information processing system 10 (transition until the load on the information processing system 10 becomes equal to or greater than the first threshold value information) with the first transition information.

This enables the VM (ASM) 33, for example, to estimate that an EDoS attack may have caused the rise in the load on the information processing system 10 to the first threshold value information, when a difference between the contents indicated by the first transition information and the contents indicated by the second transition information is equal to or greater than a predetermined reference value (hereinafter also referred to as determination information).

On the other hand, when the difference is less than the determination information, for example, this enables the VM (ASM) 33 to determine that the rise in the load on the information processing system 10 to the first threshold value information is not caused by an external attack (EDoS attack), but due to an increase in the usage of the service. Therefore, in this case, for example, the VM (ASM) 33 is enabled to determine such that an instruction to generate a new VM (AP) 32 is to be transmitted to the management device 1.

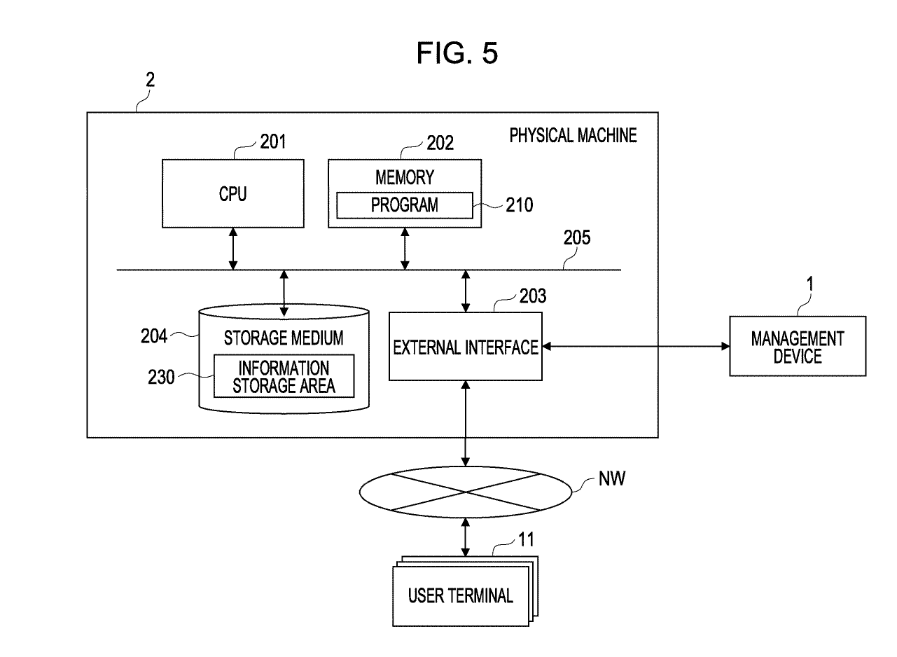

A description on a hardware configuration of the physical machine 2 follows. FIG. 5 is a diagram illustrating a hardware configuration of the physical machine 2.

The physical machine 2 includes a central processing unit (CPU) 201 that is a processor, a memory 202, an external interface 203 (I/O unit), and a storage medium 204. These units are coupled to each other through a bus 205.

The storage medium 204 stores, for example, a program 210 for executing the processing (hereinafter also referred to as external attack estimation processing or estimation processing) to estimate whether or not an external attack against the information processing system 10 is present, in a program storage area (not illustrated) of the storage medium 204. In addition, the storage medium 204 includes, for example, an information storage area 230 (hereinafter also referred to as a storage unit 230) that stores therein information used when the external attack estimation processing is executed.

As illustrated in FIG. 5, the CPU 201 loads the program 210 from the storage medium 204 to the memory 202 when executing the program 210, and executes the external attack estimation processing in collaboration with the program 210.

The external interface 203 performs communication, for example, with the management device 1. In addition, the external interface 203 performs communication, for example, with the user terminal 11 through the network NW.

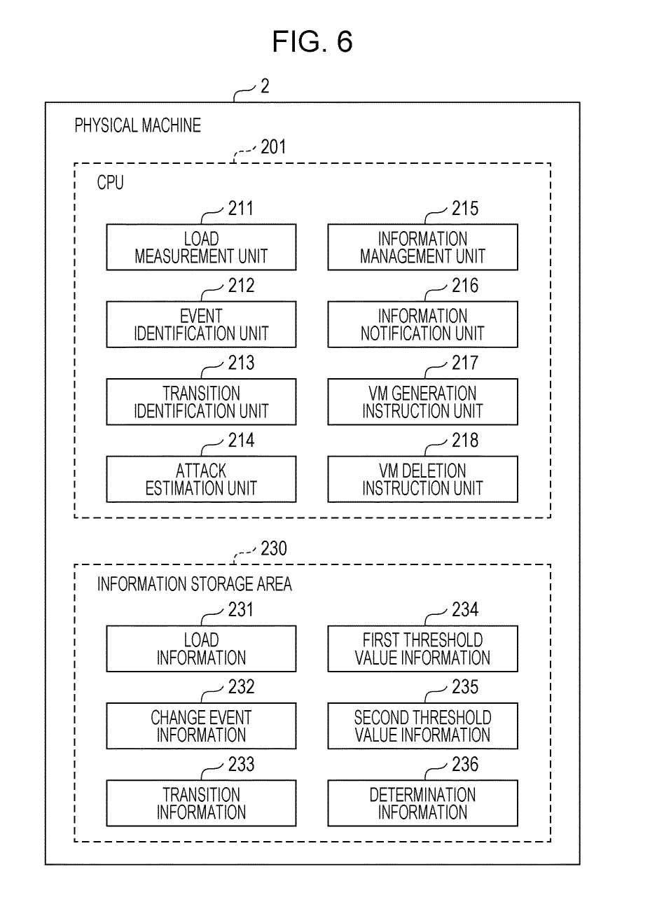

A description on functions of the VM (ASM) 33 deployed in the physical machine 2 follows. FIG. 6 is a diagram illustrating a functional configuration of the VM (ASM) 33.

The CPU 201 of the physical machine 2 allocated to the VM (ASM) 33 operates, for example, as a load measurement unit 211, an event identification unit 212, a transition identification unit 213, and an attack estimation unit 214, by collaborating with the program 210. In addition, the CPU 201 of the physical machine 2 allocated to the VM (ASM) 33 also operates, for example, as an information management unit 215, an information notification unit 216, a VM generation instruction unit 217, and a VM deletion instruction unit 218, by collaborating with the program 210.

In addition, in the information storage area 230, load information 231, change event information 232, transition information 233, first threshold value information 234, second threshold value information 235, and determination information 236 are stored.

The load measurement unit 211 measures the load on a resource of the information processing system 10, at a predetermined time interval (for example, every two minutes). The load measurement unit 211 generates load information 231 on the basis of the measured load.

Specifically, the load measurement unit 211 measures the load information 231 of the resource, for example, for each of the VMs (AP) 32 deployed in the physical machine 2. The resource to be measured for the load may be, for example, the CPU, the memory, and the like of the physical machine 2 allocated to each of the VMs (AP) 32. A specific example of the load information 231 is described later.

When the load on the resource of the information processing system 10 measured by the load measurement unit 211 becomes equal to or greater than the first threshold value information 234, the event identification unit 212 identifies, out of the change event information 232 stored in the information storage area 230, a change event corresponding to the current timing. The change events includes, for example, an event such as an addition of a new service provided to the user by the processing executed by the VM (AP) 32, a periodic maintenance performed for the information processing system 10. The change event information 232 is information in which a change event for the information processing system 10 and an occurrence timing of each change event are associated with each other. A specific example of the change event information 232 is described later.

The first threshold value information 234 may be, for example, a value at which the VM (ASM) 33 determines that a new VM (AP) 32 is to be generated. Specifically, in a case in which a resource to be measured the load thereon is the CPU, the event identification unit 212 may identify a change event that corresponds to the current timing, for example, when a VM (AP) 32 having the CPU usage rate equal to or greater than 90% is present. In a case in which a resource to be measured the load thereon is the memory, the event identification unit 212 may identify a change event corresponding to the current timing, for example, when a VM (AP) 32 having the memory usage equal to or greater than 5.0 MB is present.

The transition identification unit 213 identifies, out of the transition information 233 stored in the information storage area 230, first transition information 241 corresponding to the change event identified by the event identification unit 212. The transition information 233 is information including the load transition since the timing at which a change event occurs in the past until the load on the resource of the information processing system 10 becomes equal to or greater than the first threshold value information 234, for each timing at which a change event occurs.

In addition, the transition identification unit 213 generates second transition information 242 that indicates the load transition since the timing at which the change event corresponding to the current timing occurs until the load on the resource of the information processing system 10 becomes equal to or greater than the first threshold value information 234.

When the load measurement unit 211 measures the loads on the resources of the plural VMs (AP) 32, the transition identification unit 213 may generate second transition information 242 regarding the load on the resource, for example, for the VM (AP) 32 in which the load on the resource becomes equal to or greater than the first threshold value information 234, out of the plural VMs (AP) 32. Specific examples of the transition information 233, the first transition information 241, and the second transition information 242 are described later.

The attack estimation unit 214 estimates whether or not an external attack against the information processing system 10 is present, on the basis of a degree of correlation between the first transition information 241 identified by the transition identification unit 213 and the second transition information 242 generated by the transition identification unit 213.

Specifically, the attack estimation unit 214 compares, for example, the first transition information 241 with the second transition information 242, and estimates that an external attack against the information processing system 10 is present when the difference between the first transition information 241 and the second transition information 242 is equal to or greater than the determination information 236 which is a predetermined reference value.

The information management unit 215 stores the load information 231 generated by the load measurement unit 211 in the information storage area 230. In addition, the information management unit 215 stores, in the information storage area 230, the change event information 232 generated in advance by the business operator. Further, the information management unit 215 generates the second transition information 242 and stores the second transition information 242 in the information storage area 230 as part of the transition information 233.

When it is estimated that an external attack is taking place against the information processing system 10, the information notification unit 216 notifies the business operator (for example, a business operator terminal that is not illustrated) of such information.

When it is estimated that no external attack is taking place against the information processing system 10, the VM generation instruction unit 217 instructs the management device 1 to generate a new VM (AP) 32.

When the load on the resource of the information processing system 10, measured by the load measurement unit 211, drops to less than the second threshold value information 235, the VM deletion instruction unit 218 instructs the management device 1 to delete an existing VM (AP) 32.

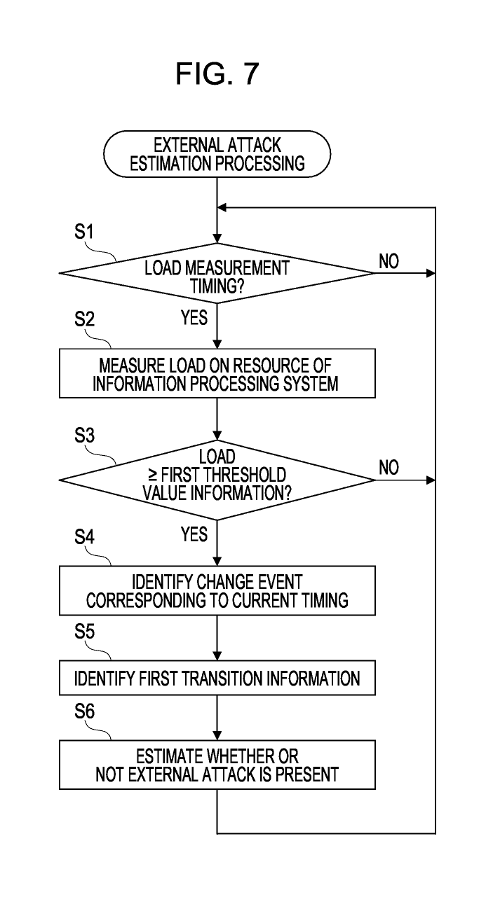

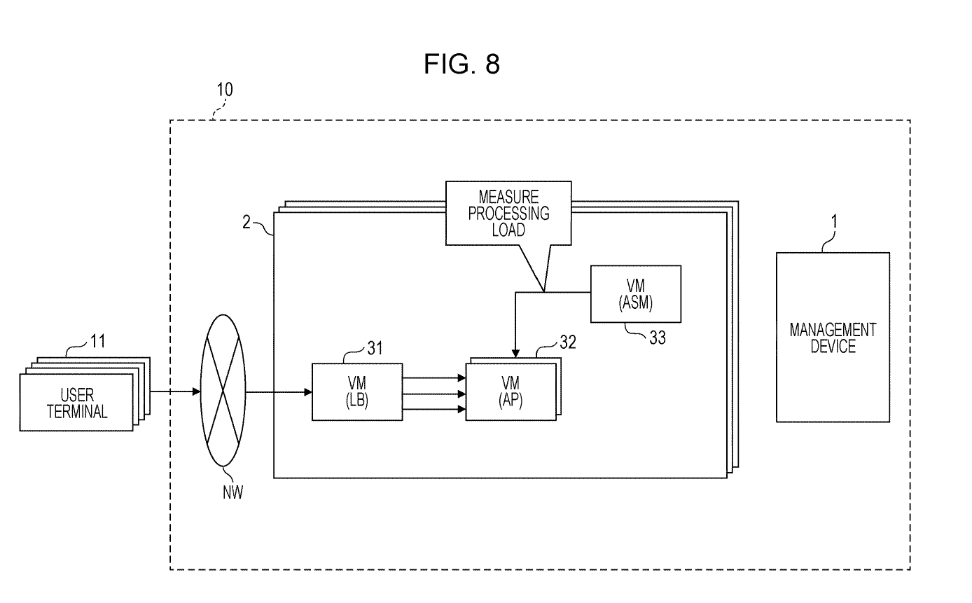

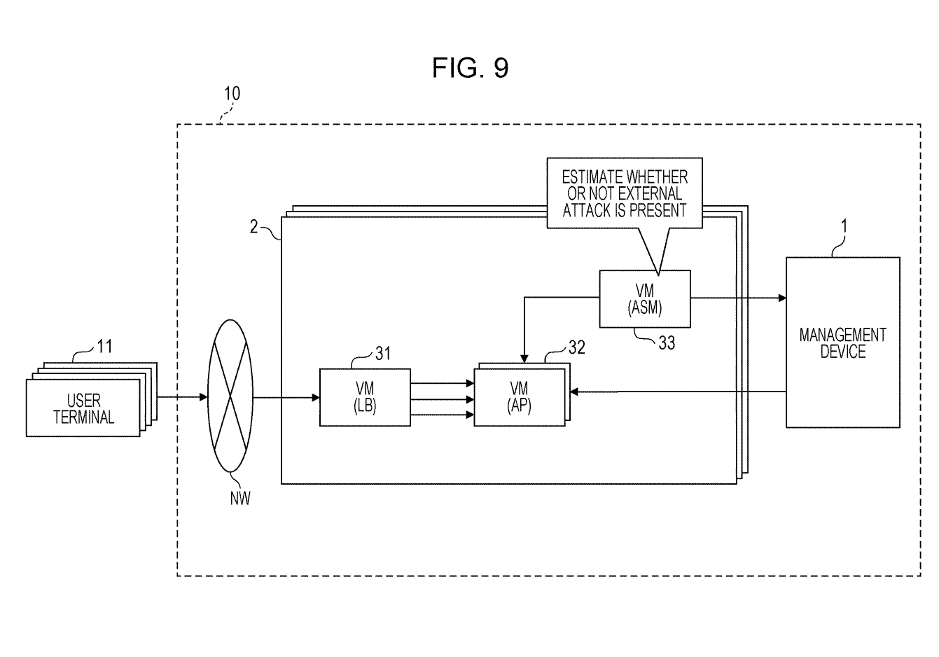

A description on operations of the VM (ASM) 33 follows. FIG. 7 is a flowchart illustrating the external attack estimation processing according to the embodiment. FIGS. 8 and 9 are diagrams each illustrating the external attack estimation processing according to the embodiment. A description follows regarding the external attack estimation processing with reference to FIGS. 7 to 9. It is assumed that the VM (ASM) 33 measures the load in the processing for the VM (AP) 32.

As illustrated in FIG. 7, the VM (ASM) 33 waits for the timing (hereinafter also referred to as load measurement timing) to measure the load on the resource allocated to the VM (AP) 32 (No in S1). The load measurement timing may be a predetermined timing such as every one minute.

Then, when it is the timing to measure the load (Yes in S1), the VM (ASM) 33 measures the load on the resource allocated to each of the VMs (AP) 32 as illustrated in FIG. 8 (S2). The VM (ASM) 33 determines whether or not a VM (AP) 32 having the load on the resource equal to or greater than the first threshold value information 234 (S3) is present. Namely, in order to determine whether or not to instruct the management device 1 to generate a new VM (AP) 32, the VM (ASM) 33 measures the load on the resource allocated to each of the VMs (AP) 32 and determines whether or not a VM (AP) 32 having the load on the resource equal to or greater than the first threshold value information 234 is present.

As a result, for example, when a VM (AP) 32 having the load on the resource equal to or greater than the first threshold value information 234 is present among the VMs (AP) 32 for which the load on the resource is measured (Yes in S3), the VM (ASM) 33 identifies the change event corresponding to the current timing (hereinafter also simply referred to as a current change event) out of the change event information 232 (S4). The VM (ASM) 33 then identifies the first transition information 241 corresponding to the change event identified in S4, on the basis of the transition information 233 (S5).

As illustrated in FIG. 9, the VM (ASM) 33 estimates whether or not an external attack is present, on the basis of a degree of correlation between the first transition information 241 identified in S5 and the second transition information indicating the load transition since the occurrence of the current change event until the load on the resource becomes equal to or greater than the first threshold value information 234 (S6).

When the rise in the load on the resource allocated to the VM (AP) 32 is caused by the current change event, the load transition of the resource allocated to the VM (AP) 32 when a similar change event to the current change event occurs in the past is similar to the current load transition of the resource allocated to the VM (AP) 32. Therefore, the VM (ASM) 33 compares the load transition (first transition information 241) of the resource allocated to the VM (AP) 32 when a similar change event to the current change event occurs previously with the current load transition (second transition information 242) of the resource allocated to the VM (AP) 32 before generating a new VM (AP) 32. The VM (ASM) 33 then estimates whether or not an external attack is present, on the basis of the comparison result between the first transition information 241 and the second transition information 242.

This enables the VM (ASM) 33 to determine whether or not the rise in the load on the resource allocated to the VM (AP) 32 is caused by an external attack (EDoS attack), before generating a new VM (AP) 32. This thereby enables the VM (ASM) 33 to transmit an instruction to generate a new VM (AP) 32 to the management device 1 only when it is determined that an external attack is not present.

In this manner, the VM (ASM) 33 according to the embodiment measures the load on the resource of the information processing system 10 (allocated to the VM (AP) 32). Then, when the measured load on the resource becomes equal to or greater than the first threshold value information 234, the VM (ASM) 33 identifies a change event that corresponds to the current timing, out of the change event information 232 in which each change event for the information processing system 10 and occurrence timing of the change event are associated with each other.

In addition, the VM (ASM) 33 identifies the first transition information 241 corresponding to the identified change event, out of the transition information 233 indicating the load transition since the timing at which each change event in the past occurs until the load on the resource becomes equal to or greater than the first threshold value information 234. The VM (ASM) 33 then estimates whether or not an external attack against the information processing system 10 is present, on the basis of a degree of correlation between the identified first transition information 241 and the second transition information 242 indicating the load transition since the timing at which the current change event occurs until the load on the resource becomes equal to or greater than the first threshold value information 234.

This enables the VM (ASM) 33 to estimate that an external attack may have caused the rise in the load on the resource allocated to the VM (AP) 32 to the first threshold value information 234, when, for example, a difference between the contents indicated by the first transition information and the contents indicated by the second transition information is equal to or greater than the determination information 236. Therefore, this enables the VM (ASM) 33 to determine that an instruction to generate a new VM (AP) 32 is not to be transmitted to the management device 1.

On the other hand, this enables the VM (ASM) 33 to determine that the rise in the load on the resource allocated to the VM (AP) 32 to the first threshold value information 234 is not caused by an external attack but by an increase in the usage of the service, when, for example, the difference between the contents indicated by the first transition information and the contents indicated by the second transition information is less than the determination information 236. This thereby enables the VM (ASM) 33 to determine that an instruction to generate a new VM (AP) 32 is to be transmitted to the management device 1.

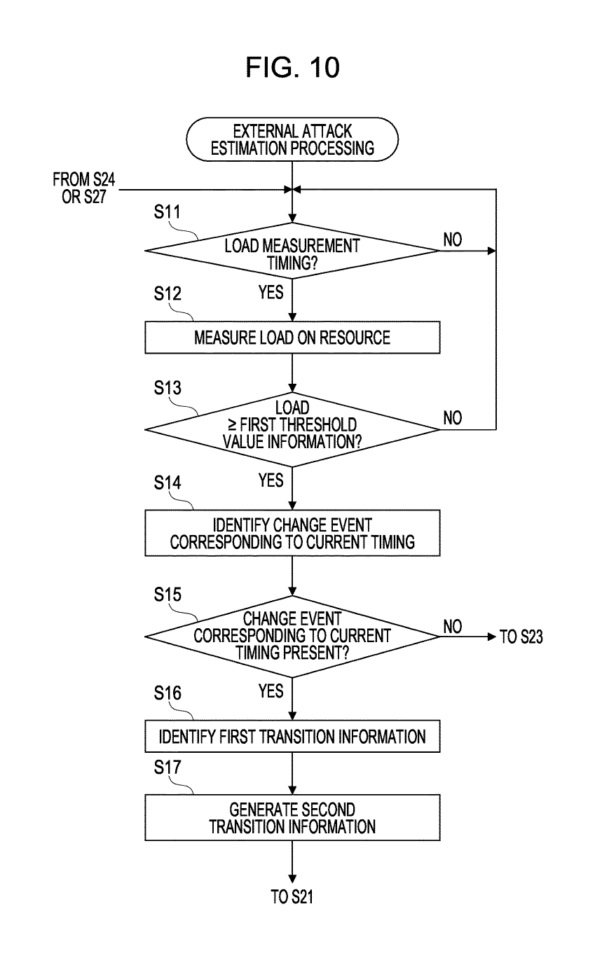

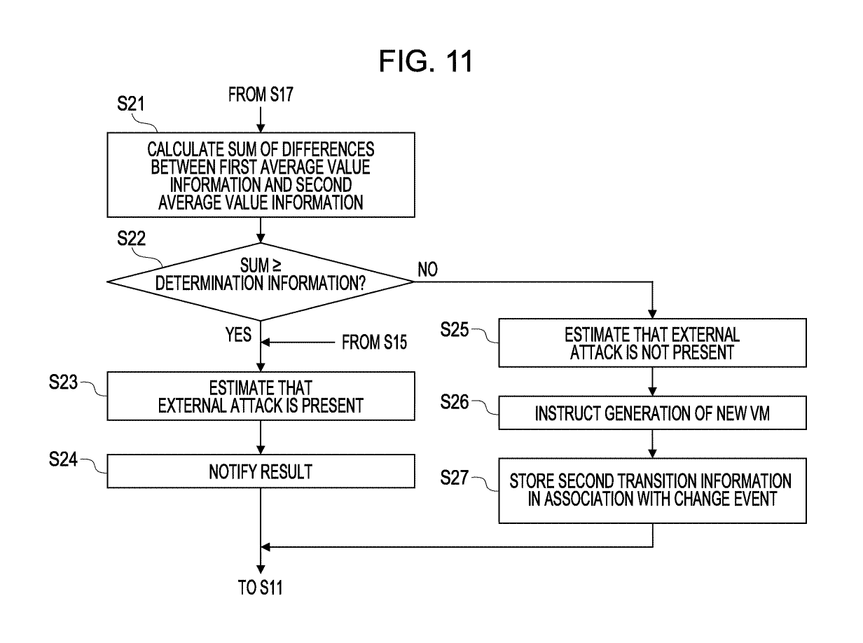

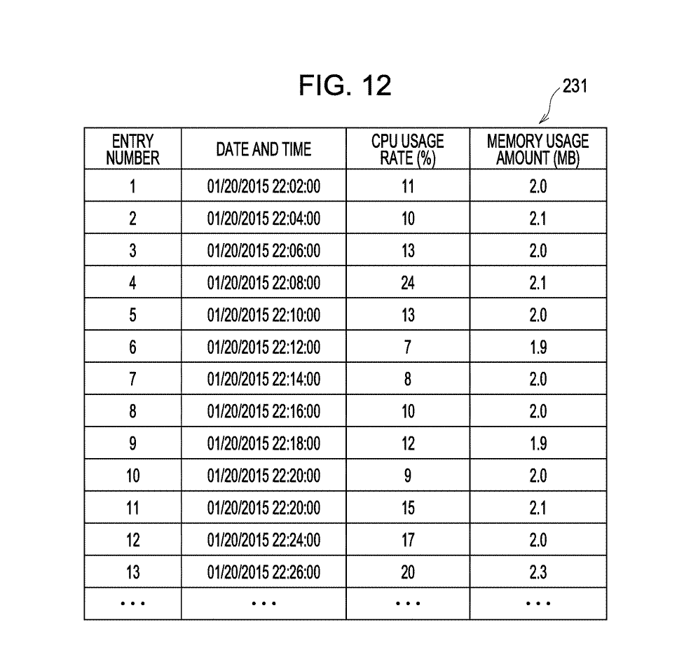

A detailed description on operations of the VM (ASM) 33 follows. FIGS. 10 and 11 are flowcharts illustrating the external attack estimation processing according to the embodiment in detail. FIGS. 12 to 19 are diagrams each illustrating the external attack estimation processing according to the embodiment. A detailed description follows regarding the external attack estimation processing with reference to FIGS. 10 to 19.

As illustrated in FIG. 10, the load measurement unit 211 of the VM (ASM) 33 waits for a load measurement timing (No in S11).

When it is the load measurement timing (Yes in S11), the load measurement unit 211 measures the load on the resource allocated to each of the VMs (AP) 32 (S12). Then, the load measurement unit 211 stores information indicating the measured load on the resource allocated to the VM (AP) 32 in the information storage area 230 as part of the load information 231. A description follows regarding a specific example of the load information 231.

FIG. 12 is a diagram illustrating a specific example of the load information 231. Each entry of the load information 231 illustrated in FIG. 12 includes “entry number” identifying each entry included in the load information 231, and “date and time” indicating when the load on the resource allocated to the VM (AP) 32 is measured by the load measurement unit 211. Each entry of the load information 231 illustrated in FIG. 12 further includes “CPU usage rate” indicating the CPU usage rate measured by the load measurement unit 211 and “memory usage amount” indicating the memory usage amount measured by the load measurement unit 211. It is assumed that the load on the resource allocated to the VM (AP) 32 is measured by the load measurement unit 211 every two minutes.

Specifically, in the load information 231 illustrated in FIG. 12, for the entry having the entry number “1”, “date and time” is set as “01/20/2015 00:02:00”, “CPU usage rate” is set as “11(%)”, and “memory usage amount” is set as “2.0 (MB)”. A description regarding other entries included in FIG. 12 is omitted.

Returning to FIG. 10, the load measurement unit 211 determines whether or not a VM (AP) 32 with the load on the resource, measured in S12, equal to or greater than the first threshold value information 234, is present (S13). As a result, for example, when a VM (AP) 32 with the load equal to or greater than the first threshold value information 234 is present among the VMs (AP) 32 for which the load on the resource is measured in S12 (Yes in S13), the event identification unit 212 of the VM (ASM) 33 identifies a current change event. Specifically, in this case, the event identification unit 212 identifies the current change event on the basis of the change event information 232 (S14).

On the other hand, for example, when a VM (AP) 32 with the load equal to or greater than the first threshold value information 234 is not present among the VMs (AP) 32 for which the load on the resource is measured in S12 (No in S13), the load measurement unit 211 waits for the next load measurement timing (No in S11).

Hereinafter, it is assumed that the resources of the VM (AP) 32 to be measured by the load measurement unit 211 are the CPU and the memory. It is also assumed that the first threshold value information 234 includes 90% that is a threshold value for the CPU usage rate and 7.0 MB that is a threshold value for the memory usage amount. Namely, the event identification unit 212 executes S14 when it is determined in S13 that a VM (AP) 32 having the CPU usage rate of 90% or greater is present. In addition, the event identification unit 212 executes S14 when it is determined in S13 that a VM (AP) 32 having the memory usage amount of 7.0 MB or greater is present. A description follows regarding a specific example of the change event information 232.

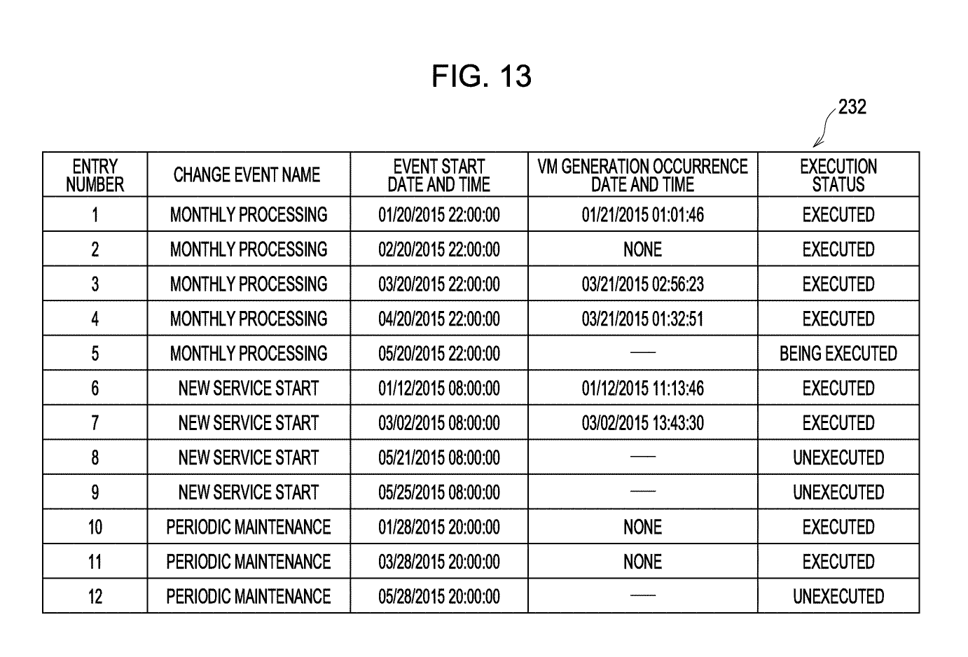

FIG. 13 is a diagram illustrating a specific example of the change event information 232. Each entry of the change event information 232 illustrated in FIG. 13 includes “entry number” identifying each entry included in the change event information 232 and “change event name” indicating each change event. Each entry of the change event information 232 illustrated in FIG. 13 also includes “event start date and time” indicating the starting date and time of the change event set to “change event name”, and “VM generation occurrence date and time” indicating a date and time when the VM (AP) 32 is generated while the change event set to “change event name” is taking place. Each entry of the change event information 232 illustrated in FIG. 13 further includes “execution status” indicating the state of execution of the change event set to “change event name”.

“Monthly processing” indicating the processing executed monthly at a date and time defined in advance, “new service start” indicating start of a new service accompanied by installation of a new application to the information processing system 10 or revision of the installed application, or “periodic maintenance” indicating the maintenance performed for the information processing system 10 periodically is set to “change event name”. Namely, events scheduled by the business operator in advance are set to “change event name”.

When no new VM (AP) 32 is generated while the change event set to “change event name” is taking place, “None” is set to “VM generation occurrence date and time”. When the change event set to “change event name” is not yet executed, “-” is set to “VM generation occurrence date and time”.

“Executed” indicating that the change event set to “change event name” is already completed, “being executed” indicating that the change event is being executed, or “unexecuted” indicating that the change event is not yet started, is set to “execution status”.

Specifically, in the change event information 232 illustrated in FIG. 13, for the entry having the entry number “1”, “change event name” is set as “monthly processing”, “event start date and time” is set as “01/20/2015 22:00:00”, “VM generation occurrence date and time” is set as “01/21/2015 01:01:46”, and “execution status” is set as “executed”.

In the change event information 232 illustrated in FIG. 13, for the entry having the entry number “2”, “change event name” is set as “monthly processing”, “event start date and time” is set as “20/02/2015 22:00:00”, “VM generation occurrence date and time” is set as “None”, and “execution status” is set as “executed”.

Namely, the change event information 232 illustrated in FIG. 13 indicates that a new VM (AP) 32 is generated when the change event of the entry having the entry number “1” is executed, and no new VM (AP) 32 is generated when the change event of the entry having the entry number “2” is executed. A description regarding the other entries included in FIG. 13 is omitted.

In S14, the event identification unit 212 identifies, for example, an entry in which “execution status” is “being executed”, out of the entries included in the change event information 232. Specifically, “execution status” of the entry having the entry number “5” is set as “being executed” in the change event information 232 illustrated in FIG. 13. Therefore, the event identification unit 212 identifies “monthly processing” that is information set to “change event name” of the entry having the entry number “5” in the change event information 232 illustrated in FIG. 13, as a change event corresponding to the current timing.

Returning to FIG. 10, after S14, the transition identification unit 213 of the VM (ASM) 33 determines whether or not a change event corresponding to the current timing is present (S15). When a change event corresponding to the current timing is present (Yes in S15), the transition identification unit 213 refers to the transition information 233 in order to execute S16. A specific example of the transition information 233 is described below.

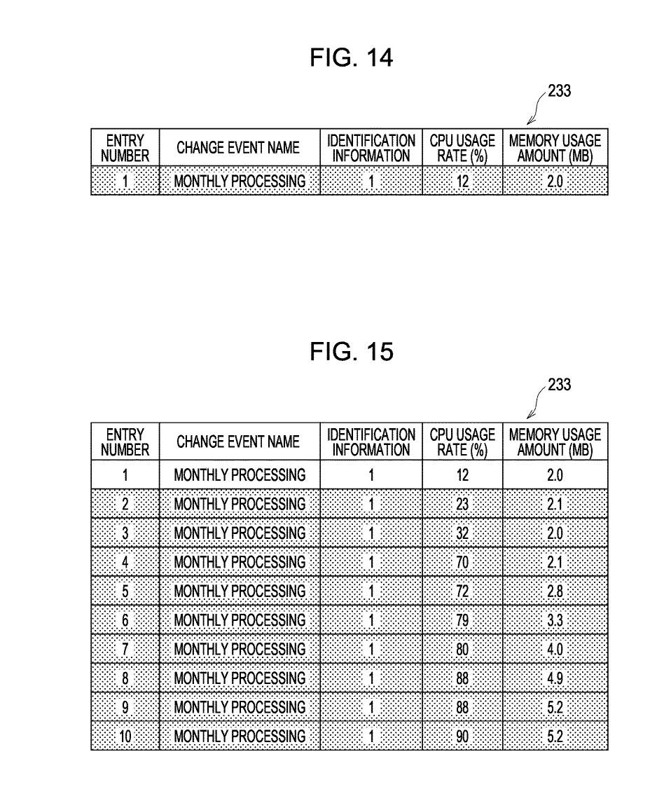

FIGS. 14 to 16 and 19 are diagrams each illustrating a specific example of the transition information 233. Each entry of the transition information 233 illustrated in FIGS. 14 to 16 and 19 includes “entry number” identifying each entry included in the transition information 233, “change event name” indicating each change event, “identification information” identifying a change event. Information set to “identification information” in the transition information 233 illustrated in FIGS. 14 to 16 and 19 corresponds to the information that is set to “entry number” in the change event information 232 illustrated in FIG. 13. Each entry of the transition information 233 illustrated in FIGS. 14 to 16 and 19 further includes “CPU usage rate (%)” and “memory usage amount (MB)” described with reference to the load information 231 illustrated in FIG. 12.

The transition information 233 is generated by the information management unit 215 of the VM (ASM) 33, on the basis of the information included in the load information 231 and the change event information 232 before the external attack estimation processing is executed. Then, as described later, the transition information 233 is updated along with the execution of the external attack estimation processing. A description follows regarding the transition information 233 generated before the external attack estimation processing is executed (hereinafter also referred to as transition information 233 in the initial state).

FIGS. 14 to 16 are diagrams each illustrating a specific example for describing the transition information 233 in the initial state. For example, when the information management unit 215 receives an instruction to generate the transition information 233 from the business operator, the information management unit 215 equally divides a time period from a date and time set to “event start date and time” to a date and time set to “VM generation occurrence date and time” by a certain number (for example, 10) for each entry having “entry number” of the change event information 232. The information management unit 215 then calculates an average value of the loads on the resource allocated to the VM (AP) 32 in each of the equally-divided time periods. In the change event information 232 illustrated in FIG. 13, for the entry having the entry number “1”, “event start date and time” is set as “01/20/2015 22:00:00” and “VM generation occurrence date and time” is set as “01/21/2015 01:01:46”. Namely, in this case, a time period from the date and time set to “event start date and time” to the date and time set to “VM generation occurrence date and time” is about three hours (about 180 minutes). Therefore, the information management unit 215 calculates an average value of the loads on the resource allocated to the VM (AP) 32 in the time period from the date and time set to “event start date and time” to the date and time set to “VM generation occurrence date and time”, for example, for each 18 minutes (180 minutes/10), with reference to the load information 231 illustrated in FIG. 12.

Specifically, the information management unit 215 obtains information set to “CPU usage rate” for the entries having the date and time “01/20/2015 22:02:00” to “01/20/2015 22:18:00” (entries corresponding to the initial 18 minutes), for example, from the load information 231 illustrated in FIG. 12. Namely, the information management unit 215 obtains “11”, “10”, “13”, “24”, “13”, “7”, “8”, “10”, and “12” (information set to “CPU usage rate” for the entries having the entry number “1” to “9” in the load information 231 illustrated in FIG. 12). The information management unit 215 then calculates “12” that is the average value of the obtained set of information. After that, as illustrated in the shaded portion of FIG. 14, the information management unit 215 sets the calculated “12(%)” to “CPU usage rate” corresponding to the entry having the entry number “1”.

In addition, the information management unit 215 obtains information set to “memory usage amount” for the entries having the date and time “01/20/2015 22:02:00” to “01/20/2015 22:18:00”, for example, from the load information 231 illustrated in FIG. 12. Namely, the information management unit 215 obtains “2.0”, “2.1”, “2.0”, “2.1”, “2.0”, “1.9”, “2.0”, “2.0”, and “1.9” (information set to “memory usage amount” for the entries having the entry number “1” to “9” in the load information 231 illustrated in FIG. 12). The information management unit 215 then calculates “2.0” that is the average value of the obtained set of information. After that, as illustrated in the shaded portion of FIG. 14, the information management unit 215 sets the calculated “2.0 (MB)” to “memory usage amount” corresponding to the entry having the entry number . . . “1”.

In this case, as illustrated in the shaded portion of FIG. 14, the information management unit 215 sets “monthly processing” to “change event name” for the entry having the entry number “1”. “Monthly processing” is information set to “change event name” for the entry having the entry number “1” in the change event information 232 illustrated in FIG. 13. In addition, as illustrated in the shaded portion of FIG. 14, the information management unit 215 sets “1” to “identification information” for the entry having the entry number “1”. “1” is the “entry number” of the entry that is currently referred to in the change event information 232 illustrated in FIG. 13.

As illustrated in the shaded portion of FIG. 15, the information management unit 215 also generates transition information 233 for time periods following the initial 18 minutes, out of the time period from the date and time set to “event start date and time” to the date and time set to “VM generation occurrence date and time” for the entry having the entry number “1” in the change event information 232 illustrated in FIG. 13.

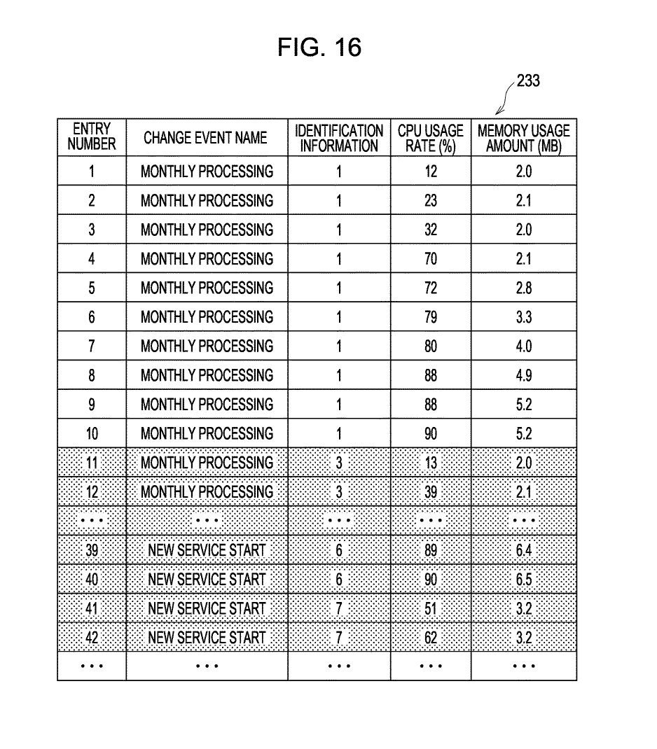

Further, the information management unit 215 generates transition information 233, for each entry having the execution status “executed” and the VM generation occurrence date and time other than “None”, out of the entries included in the change event information 232 illustrated in FIG. 13. Namely, as illustrated in the shaded portion of FIG. 16, the information management unit 215 also generates transition information 233 for the entries having the entry numbers “3”, “4”, “6”, and “7”, respectively, out of the entries included in the change event information 232 illustrated in FIG. 13.

This enables the information management unit 215 to generate the transition information 233 so as to include information used for determining whether or not the information processing system 10 is receiving an external attack. A description regarding the other information included in FIGS. 14 to 16 is omitted.

Returning to FIG. 10, the transition identification unit 213 identifies first transition information 241 corresponding to the change event that is identified in S14, from the transition information 233 (S16).

Specifically, when the change event that is identified in S14 is “monthly processing”, the transition identification unit 213 identifies, as the first transition information 241, an entry having the change event name “monthly processing”, from the transition information 233 illustrated in FIG. 14 (S16). A description follows regarding specific example of the first transition information 241.

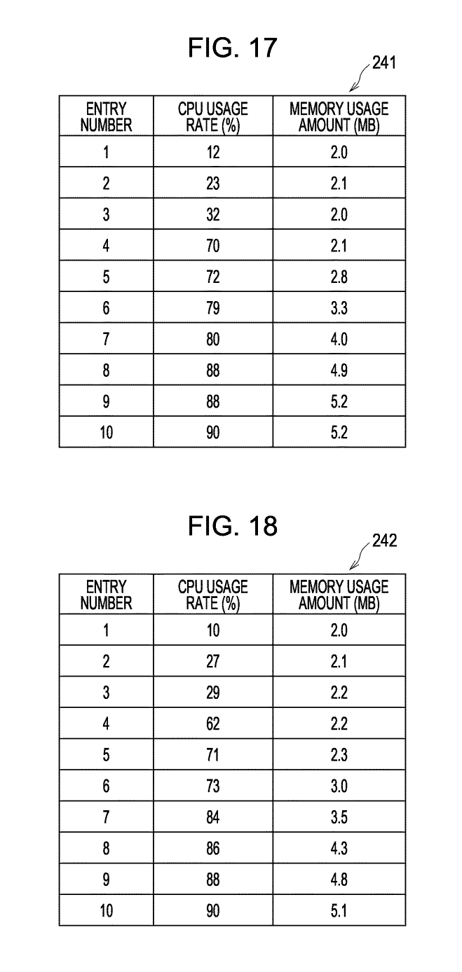

FIG. 17 is a diagram illustrating a specific example of the first transition information 241. Each entry of the first transition information 241 illustrated in FIG. 17 includes “entry number” identifying each entry included in the first transition information 241, and “CPU usage rate” and “memory usage amount” described with reference to the load information 231 illustrated in FIG. 12. A description follows assuming that “monthly processing” is identified as a change event corresponding to the current timing in S14.

Specifically, the same pieces of information set to “CPU usage rate” and “memory usage amount” for the entries having the change event name “monthly processing” and the identification information “1” out of the transition information 233 illustrated in FIG. 16 are set for the first transition information 241 illustrated in FIG. 17. A description on the other information included in FIG. 17 is omitted herein.

In the change event information 232 illustrated in FIG. 13, the entries for which “monthly processing” is set to “change event name”, information other than “None” is set to “VM generation occurrence date and time”, and “executed” is set to “execution status” have the entry numbers “1”, “3”, or “4”, respectively. Therefore, the transition identification unit 213 also generates first transition information 241 for the entries having the entry numbers “3” and “4”, respectively, in the change event information 232 illustrated in FIG. 13, in addition to the first transition information 241 described with reference to FIG. 17. Hereinafter, the pieces of first transition information 241 for the entries having the entry numbers “1”, “3”, and “4”, respectively, in the change event information 232 illustrated in FIG. 13 are also referred to as the first transition information 241a, the first transition information 241b, and the first transition information 241c.

Returning to FIG. 10, the information management unit 215 generates second transition information 242 (S17) indicating the load transition since the occurrence of the change event identified in S14 until the load on the resource becomes equal to or greater than the first threshold value information 234. A description follows regarding a specific example of the second transition information 242.

FIG. 18 is a diagram illustrating a specific example of the second transition information 242. Each entry of the second transition information 242 illustrated in FIG. 18 includes identical items to each entry of the first transition information 241 illustrated in FIG. 17. A description follows assuming that the current date and time (date and time at which S13 is executed) is “05/21/2015 00:01:32”.

In S17, the information management unit 215 equally divides a time period from the date and time set to “event start date and time” of the entry having the entry number “5”, in which “execution status” is set as “being executed”, in the change event information 232 illustrated in FIG. 13, to the current date and time, by a certain number (for example, 10). The information management unit 215 then generates second transition information 242 by calculating an average value of the loads on the resource allocated to the VM (AP) 32 in each of the equally-divided time periods.

Specifically, in the change event information 232 illustrated in FIG. 13, “05/20/2015 22:00:00” is set to “event start date and time” for the entry having the entry number “5”. Namely, in this case, a time period from the date and time set to “event start date and time” for the entry to the current date and time “05/21/2015 00:01:32” is about two hours (about 120 minutes). Therefore, in this case, the information management unit 215 calculates an average value of the loads on the resource allocated to the VM (AP) 32 in a time period from the date and time set to “event start date and time” for the entry to the current date and time, for every 12 minutes (120 minutes/10), similarly to the case described with reference to FIG. 14 and the like.

For example, when an average value of the loads on the VM (AP) 32 (average value of the CPU usage rate in the initial 12 minutes) is “10”, as illustrated in FIG. 18, the information management unit 215 sets “10(%)” to “CPU usage rate” for the entry having the entry number “1”. In addition, for example, when an average value of the loads on the VM (AP) 32 (average value of the memory usage amount in the initial 12 minutes) is “2.0”, as illustrated in FIG. 18, the information management unit 215 sets “2.0 (MB)” to “memory usage amount” for the entry having the entry number “1”. A description on the other information included in FIG. 18 is omitted.

Returning to FIG. 11, the attack estimation unit 214 of the VM (ASM) 33 calculates a sum of differences between information included in the first transition information 241 and corresponding information included in the second transition information 242 generated in S17 that have an identical time-series order, for each of the first transition information 241 identified in S16 (S21). Hereinafter, the pieces of information included in the first transition information 241 are also referred to as pieces of first average value information 241, and the pieces of information included in the second transition information 242 are also referred to as pieces of second average value information 242.

Specifically, the attack estimation unit 214 calculates a difference (absolute value of the difference) of pieces of information between the first transition information 241a illustrated in FIG. 17 and the second transition information 242 illustrated in FIG. 18, for each entries having the same entry number. For example, “12” is set to “CPU usage rate” of the entry having the entry number “1” in the first transition information 241a illustrated in FIG. 17, and “10” is set to “CPU usage rate” of the entry having the entry number “1” in the second transition information 242 illustrated in FIG. 18. Therefore, the attack estimation unit 214 calculates “2” as an absolute value of the difference between the entries having the entry number “1”.

In addition, “23” is set to “CPU usage rate” of the entry having the entry number “2” in the first transition information 241a illustrated in FIG. 17, and “27” is set to “CPU usage rate” of the entry having the entry number “2” in the second transition information 242 illustrated in FIG. 18. Therefore, the attack estimation unit 214 calculates “4” as an absolute value of the difference of information between the entries having the entry number “2”.

Similarly, the attack estimation unit 214 calculates “3”, “8”, “1”, “6”, “4”, “2”, “0”, and “0” as absolute values of differences between the entries having the entry numbers “3” to “10”, respectively. Then, the attack estimation unit 214 calculates “30” as a sum of the absolute values of the differences between the entries having the entry numbers “1” to “10”, respectively, in the first transition information 241a and the second transition information 242.

In addition, the attack estimation unit 214 calculates a sum of differences between each of the other first transition information 241 (first transition information 241b and first transition information 241c) that are identified in S16 and the second transition information 242 that is generated in S17. A description follows assuming that a sum of differences between the entries in the first transition information 241b and the second transition information 242 is “60”, and a sum of differences between the entries in the first transition information 241c and the second transition information 242 is “10”.

Returning to FIG. 11, the attack estimation unit 214 determines whether or not any first transition information 241 for which the sum calculated in S21 is equal to or greater than the determination information 236 is present, out of the first transition information 241 identified in S16 (S22). When the attack estimation unit 214 determines that first transition information 241 for which the sum calculated in S21 is equal to or greater than the determination information 236 is present (Yes in S22), the attack estimation unit 214 estimates that the information processing system 10 is receiving an external attack (S23).

Namely, when the attack estimation unit 214 determines that the first transition information 241 for which the sum calculated in S21 is equal to or greater than the determination information 236 is present, the attack estimation unit 214 determines that the load transition of the resource of the information processing system 10 deviates from the load transition at the time when a similar change event is being executed in the past. Therefore, the attack estimation unit 214 determines that the rise in the load on the resource of the information processing system 10 is not caused by the change event that is currently being executed. Thus, in this case, the attack estimation unit 214 estimates that an external attack is being made against the information processing system 10. Alternatively, the attack estimation unit 214 may determine, in S22, whether or not any first transition information 241 for which the sum calculated in S21 is equal to or less than the determination information 236 is present, and may estimate, in S23, that the information processing system 10 is receiving an external attack when the attack estimation unit 214 determines that no first transition information 241 for which the sum calculated in S21 is equal to or less than the determination information 236 is present.

This enables the attack estimation unit 214 to detect, for example, an attack against the information processing system 10 even when the attack is performed, as in the case of an EDoS attack, by transmitting to the information processing system 10 processing requests slightly more than the processing requests transmitted by a normal user. This thereby enable the attack estimation unit 214 to extend the range of external attacks the attack estimation unit 214 is capable of estimating.

Specifically, in S22, for example, when the determination information 236 is “50”, “60” that is the sum of the differences between the first transition information 241b and the second transition information 242 is equal to or greater than the determination information 236 (Yes in S22). Therefore, in this case, the attack estimation unit 214 executes S23 and the subsequent processing.

On the other hand, in S22, for example, when the determination information 236 is “80”, all of the sums of the differences calculated in S21 are less than the determination information 236 (No in S22). Therefore, in this case, the attack estimation unit 214 executes S25 and the subsequent processing.

When no change event corresponding to the current timing is present (No in S15), the attack estimation unit 214 executes S23. Namely, when a change event corresponding to the current timing is not present in the change event information 232, the load on the resource allocated to the VM (AP) 32 is assumed to have risen due to a cause other than the change events presupposed in the change event information 232 with a possibility to raise the load on the resource allocated to the VM (AP) 32. Therefore, in this case too, the attack estimation unit 214 estimates that an external attack is being made against the information processing system 10.

Then, after S23, the information notification unit 216 of the VM (ASM) 33 notifies the business operator of the result of S23 (S24). Specifically, the information notification unit 216 transmits, to the business operator (for example, business operator terminal that is not illustrated), information indicating that it is possible that the rise in the load on the resource allocated to the VM (AP) 32 is caused by an external attack. This enables the business operator to recognize the possibility of the presence of external attack against the information processing system 10. This thereby enables the business operator to investigate, etc. as appropriate, as to whether or not an external attack against the information processing system 10 is present.

In this case, the VM generation instruction unit 217 does not instruct the management device 1 to generate a new VM (AP) 32. This enables the VM (ASM) 33 to avoid generating a new VM (AP) 32 accompanying the rise in the load on the resource, which may occur due to an external attack. This thereby enables the business operator to avoid being forced an economic burden due to an external attack against the information processing system 10.

On the other hand, when it is determined that no first transition information 241 for which the sum calculated in S21 is equal to or greater than the determination information 236 is present (No in S22), the attack estimation unit 214 estimates that an external attack is not being made against the information processing system 10 (S25). The VM generation instruction unit 217 then instructs the management device 1 to generate a new VM (AP) 32 in this case (S26). This enables the VM generation instruction unit 217 to instruct the management device 1 to generate a new VM (AP) 32 when the attack estimation unit 214 determines that no external attack against the information processing system 10 is present.

Then, the information management unit 215 stores the second transition information 242 generated in S17 in the information storage area 230 as part of the transition information 233 in association with the change event identified in S14 (S27). A description follows regarding specific example of the transition information 233 after S27 is executed.

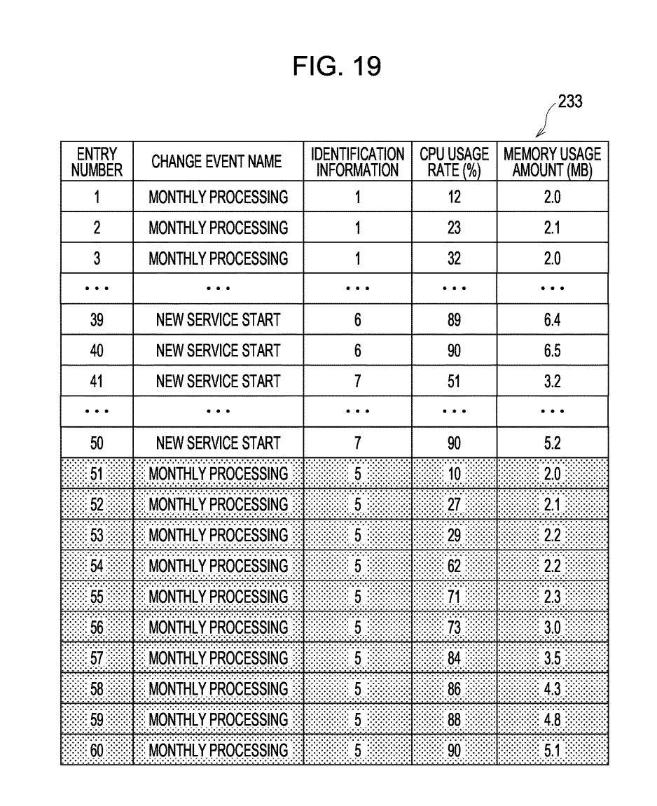

FIG. 19 is a diagram illustrating a specific example of the transition information 233 after S27 is executed. The transition information 233 illustrated in FIG. 19 is transition information 233 when information (shaded portion of FIG. 19) corresponding to the second transition information 242 illustrated in FIG. 18 is added to the transition information 233 illustrated in FIG. 16.

Specifically, in S27, the information management unit 215 sets “monthly processing” that is the information set to “change event name” of the entry having the execution status “being executed” in the change event information 232 illustrated in FIG. 13, as “change event name” of the entry having the entry number “51”. In addition, the information management unit 215 sets “5” that is the information set to “entry number” of the entry having the execution status “being executed” in the change event information 232 illustrated in FIG. 13, as “identification information” of the entry having the entry number “51”.

The information management unit 215 sets “10(%)” that is the information set to “CPU usage rate” for the entry having the entry number “1” in the second transition information 242 illustrated in FIG. 18, as “CPU usage rate” for the entry having the entry number “51”. In addition, the information management unit 215 sets “2.0 (MB)” that is the information set to “memory usage amount” for the entry having the entry number “1” in the second transition information 242 illustrated in FIG. 18, as “memory usage amount” of the entry having the entry number “51”. A description on the other information included in FIG. 19 is omitted.

Namely, in this case, the information management unit 215 updates the transition information 233 stored in the information storage area 230, on the basis of information on the second transition information 242 generated in S17. This enables the information management unit 215 to execute the processing with reference to the more accurate transition information 233 when the information management unit 215 executes S11 and the subsequent processing again.

As described above, the VM (ASM) 33 according to the embodiment measures the load on the resource of the information processing system 10 (VM (AP) 32). When the measured load on the resource becomes equal to or greater than the first threshold value information 234, the VM (ASM) 33 identifies a change event corresponding to the current timing out of the change event information 232 in which each change event for the information processing system 10 and occurrence timing of the change event are associated with each other.

The VM (ASM) 33 identifies the first transition information 241 corresponding to the identified change event, out of the transition information 233 indicating the load transition since the timing in the past at which each change event occurs until the load on the resource becomes equal to or greater than the first threshold value information 234. The VM (ASM) 33 then estimates whether or not an external attack against the information processing system 10 is present, on the basis of a degree of correlation between the identified first transition information 241 and the second transition information 242 indicating the load transition since the timing at which the identified change event occurs until the load on the resource becomes equal to or greater than the first threshold value information 234.

This enables the VM (ASM) 33, for example, to estimate that it is possible that the rise in the load on the resource allocated to the VM (AP) 32 to the first threshold value information 234 is caused by an external attack, when the difference between the contents indicated by the first transition information and the contents indicated by the second transition information is equal to or greater than the determination information 236.

On the other hand, this enables the VM (ASM) 33, for example, to determine that the rise in the load on the resource allocated to the VM (AP) 32 to the first threshold value information 234 is not caused by an external attack but by an increase in the usage amount of the service, when the difference between the contents indicated by the first transition information and the contents indicated by the second transition information is less than the determination information 236. In this case, this enables, for example, the VM (ASM) 33 to determine that an instruction to generate a new VM (AP) 32 is to be transmitted to the management device 1.

Note that the information management unit 215 may delete information not used for the external attack estimation processing out of the load information 231 stored in the information storage area 230, at a predetermined timing. Specifically, the information management unit 215 may delete information other than the information with a possibility to be used when the second transition information 242 is generated in S17, out of the load information 231 stored in the information storage area 230. This enables the information management unit 215 to suppress the size of the information storage area 230 desired for storing the load information 231.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
measuring a load value of a load on a resource of an information processing system;
identifying, when the measured load value reaches a predetermined value or more, a first change event corresponding to a current timing from change event information stored in a memory, the change event information including change events for the information processing system in association with occurrence timings at which the respective change events occur;
identifying first transition information corresponding to the first change event from a transition information pool stored in the memory, the transition information pool including pieces of transition information indicating transition of a first load value of the load since the occurrence timings at which the respective change events occur until the first load value reaches the predetermined value or more; and
estimating whether or not an external attack against the information processing system is present on basis of a degree of correlation between the first transition information and second transition information indicating transition of a second load value of the load since a first timing at which the first change event occurs until the second load value reaches the predetermined value or more.

2. The non-transitory computer-readable recording medium according to claim 1, the process further comprising:
adding the second transition information to the transition information pool in association with the first change event to store the second transition information in the memory.

3. The non-transitory computer-readable recording medium according to claim 1, wherein
one or more virtual machines operate in the information processing system by using the resource of the information processing system, and
the predetermined value is a value corresponding to a third load value of the load when a new virtual machine is to be generated in the information processing system.

4. The non-transitory computer-readable recording medium according to claim 3, the process further comprising:
generating a new virtual machine in the information processing system when it is estimated that no external attack against the information processing system is present.

5. The non-transitory computer-readable recording medium according to claim 1, wherein
the first transition information includes first average values of the first load value for respective time periods obtained by dividing a first time period by a predetermined number, the first time period being a time period since an occurrence timing at which a change event occurs until the first load value reaches the predetermined value or more,
the second transition information includes second average values of the second load value for respective time periods obtained by dividing a second time period by the predetermined number, the second time period being a time period since a first occurrence timing at which the first change event occurs until the second load value reaches the predetermined value or more, and
the process further comprises:
calculating a sum of differences between the respective first average values and the respective second average values having identical time-series order; and
estimating that an external attack against the information processing system is present when the calculated sum is equal to or greater than a predetermined reference value.

6. An estimation device, comprising:
a memory; and
a processor coupled to the memory and the processor configured to:
measure a load value of a load on a resource of an information processing system;
identify, when the measured load value reaches a predetermined value or more, a first change event corresponding to a current timing from change event information stored in the memory, the change event information including change events for the information processing system in association with occurrence timings at which the respective change events occur;
identify first transition information corresponding to the first change event from a transition information pool stored in the memory, the transition information pool including pieces of transition information indicating transition of a first load value of the load since the occurrence timings at which the respective change events occur until the first load value reaches the predetermined value or more; and
estimate whether or not an external attack against the information processing system is present on basis of a degree of correlation between the first transition information and second transition information indicating transition of a second load value of the load since a first timing at which the first change event occurs until the second load value reaches the predetermined value or more.

7. The estimation device according to claim 6, wherein
the processor is further configured to:
add the second transition information to the transition information pool in association with the first change event to store the second transition information in the memory.

8. The estimation device according to claim 6, wherein
one or more virtual machines operate in the information processing system by using the resource of the information processing system, and
the predetermined value is a value corresponding to a third load value of the load when a new virtual machine is to be generated in the information processing system.

9. The estimation device according to claim 8, wherein
the processor is further configured to:
generate a new virtual machine in the information processing system when it is estimated that no external attack against the information processing system is present.

10. The estimation device according to claim 6, wherein
the first transition information includes first average values of the first load value for respective time periods obtained by dividing a first time period by a predetermined number, the first time period being a time period since an occurrence timing at which a change event occurs until the first load value reaches the predetermined value or more,
the second transition information includes second average values of the second load value for respective time periods obtained by dividing a second time period by the predetermined number, the second time period being a time period since a first occurrence timing at which the first change event occurs until the second load value reaches the predetermined value or more, and
the processor is further configured to:
calculate a sum of differences between the respective first average values and the respective second average values having identical time-series order; and
estimate that an external attack against the information processing system is present when the calculated sum is equal to or greater than a predetermined reference value.

11. An estimation method, comprising:
measuring, by a computer, a load value of a load on a resource of an information processing system;
identifying, when the measured load value reaches a predetermined value or more, a first change event corresponding to a current timing from change event information stored in a memory, the change event information including change events for the information processing system in association with occurrence timings at which the respective change events occur;
identifying first transition information corresponding to the first change event from a transition information pool stored in the memory, the transition information pool including pieces of transition information indicating transition of a first load value of the load since the occurrence timings at which the respective change events occur until the first load value reaches the predetermined value or more; and
estimating whether or not an external attack against the information processing system is present on basis of a degree of correlation between the first transition information and second transition information indicating transition of a second load value of the load since a first timing at which the first change event occurs until the second load value reaches the predetermined value or more.

12. The estimation method according to claim 11, further comprising:
adding the second transition information to the transition information pool in association with the first change event to store the second transition information in the memory.

13. The estimation method according to claim 11, wherein
one or more virtual machines operate in the information processing system by using the resource of the information processing system, and
the predetermined value is a value corresponding to a third load value of the load when a new virtual machine is to be generated in the information processing system.

14. The estimation method according to claim 13, further comprising:
generating a new virtual machine in the information processing system when it is estimated that no external attack against the information processing system is present.

15. The estimation method according to claim 11, wherein
the first transition information includes first average values of the first load value for respective time periods obtained by dividing a first time period by a predetermined number, the first time period being a time period since an occurrence timing at which a change event occurs until the first load value reaches the predetermined value or more,
the second transition information includes second average values of the second load value for respective time periods obtained by dividing a second time period by the predetermined number, the second time period being a time period since a first occurrence timing at which the first change event occurs until the second load value reaches the predetermined value or more, and
the estimation method further comprises:
calculating a sum of differences between the respective first average values and the respective second average values having identical time-series order; and
estimating that an external attack against the information processing system is present when the calculated sum is equal to or greater than a predetermined reference value.
